(19) United States
(12) Patent Application Publication
(10) Pub. No.: US 2015/0336777 A1
(43) Pub. Date: Nov. 26, 2015

(54) CRANE ARRANGEMENT

(71) Applicant: CASCARL PTY LTD, Wanneroo, Western Australia (AU)

(72) Inventor: Trevor HANKS, Wanneroo, Western Australia (AU)

(73) Assignee: Rapid Pole Replacement Pty Ltd., Wanneroo, Western Australia (AU)

(21) Appl. No.: 14/410,638

(22) PCT Filed: Jun. 28, 2013
(86) PCT No.: PCT/AU2013/000702

§ 371 Date: Dec. 23, 2014

(30) Foreign Application Priority Data
Jun. 29, 2012 (AU) 2012902776

(51) Int. Cl. B66C 23/42; B66C 23/00; B66C 23/78

(52) U.S. Cl. CPC B66C 23/42; B66C 23/78; B66C 23/54

(57) ABSTRACT

A crane arrangement primarily designed for the repair and replacement of power poles is described. The arrangement includes a truck having two cranes deployed on the truck bed: one crane to hold power lines and the other to manipulate the power pole.

### FIELD OF THE INVENTION

The present invention relates to the arrangement of cranes mounted onto moving platforms, such as the beds of trucks. In particular, the invention is concerned with the use of truck-mounted cranes in servicing and replacing power poles.

### BACKGROUND TO THE INVENTION

Maintenance and construction tasks frequently involve the use of cranes, for many purposes. These purposes include the lifting and movement of items being installed or replaced; the holding of raised items (such as power lines) while supports are being installed or replaced; and the movement of workers into elevated positions.

Frequently, these tasks may involve the use of more than one crane. For instance, when a power pole is being replaced one crane may be required to hold power lines safely above the ground while another crane is used in the replacing of the power pole itself.

Similar situations are found in the replacement of railway sleepers, where one crane may be used to safely hold railway lines while another replaces the sleeper.

The requirement for two cranes to perform separate tasks can add significant complications to many repair and construction tasks. There are often access issues, where only one crane can be readily located in a desired location, meaning that the other must be positioned at a distance from the task. This, in turn, can require a heavier and more expensive second crane than would otherwise be the case.

The need for two cranes can also add significantly to the costs of the task, as two cranes and crane operators must be used for the duration of a task, even when one of them is simply tasked with holding power lines out of the way of the other.

The present invention has been devised in the light of these issues.

### SUMMARY OF THE INVENTION

According to one aspect of the present invention there is provided a crane transport vehicle, the transport vehicle including a crane supporting platform, wherein at least two separably operable cranes are disposed on the crane supporting platform, each crane being arranged to extend beyond a horizontal periphery of the transport vehicle.

Preferably, each crane is able to slew through at least 180°.

It is preferred that each crane is able to slew through at least 360°. In a preferred embodiment of the invention, each crane is able to slew through at least 400°.

The two separably operable cranes may comprise a first crane and a second crane. Preferably, one of the first and second cranes has a longer reach than the other of the first and second cranes. Also preferably, one of the first and second cranes has greater lifting capacity (for instance as rated by maximum lifting moment) than the other of the first and second cranes. Most preferably, the second crane has a longer reach than the first crane and the first crane has greater lifting capacity than the second crane.

At least one crane may also be equipped with a fly boom. This may be hydraulically operated or manually operated.

The first crane and the second crane may both be general purpose cranes. Alternatively, at least one of the first and second cranes may be a specialised crane. In one embodiment of the invention, the first crane is a crane borer such as that manufactured by Premier Proline Pty Ltd.

Having the cranes separably operable may allow a single operator to operate each crane in turn.

Both cranes may be hydraulically operated. It is preferred that a single hydraulic pump is used to supply hydraulic pressure to both cranes. A selectively operable switching means, such as a valve, may be used to cause the supply of hydraulic pressure to only operate a chosen one of the two cranes at any one time. Alternatively, each crane may have its own associated hydraulic pump.

In a preferred embodiment of the invention, the crane supporting platform represents a bed of the vehicle, with a first crane located towards the rear of the bed and a second crane located towards the front of the bed.

The vehicle may include extendable outriggers. It is preferred that the vehicle includes at least two sets of outriggers, one associated with each crane.

### BRIEF DESCRIPTION OF THE DRAWINGS

It will be convenient to further describe the invention with reference to preferred embodiments of the present invention. Other embodiments are possible, and consequently the particularity of the following discussion is not to be understood as superseding the generality of the preceding description of the invention. In the drawings:

FIG. 1 is a schematic side view of a portion of a truck incorporating the present invention; and

FIGS. 2 to 7 are successive perspectives of the truck of FIG. 1 being used to remove a power pole.

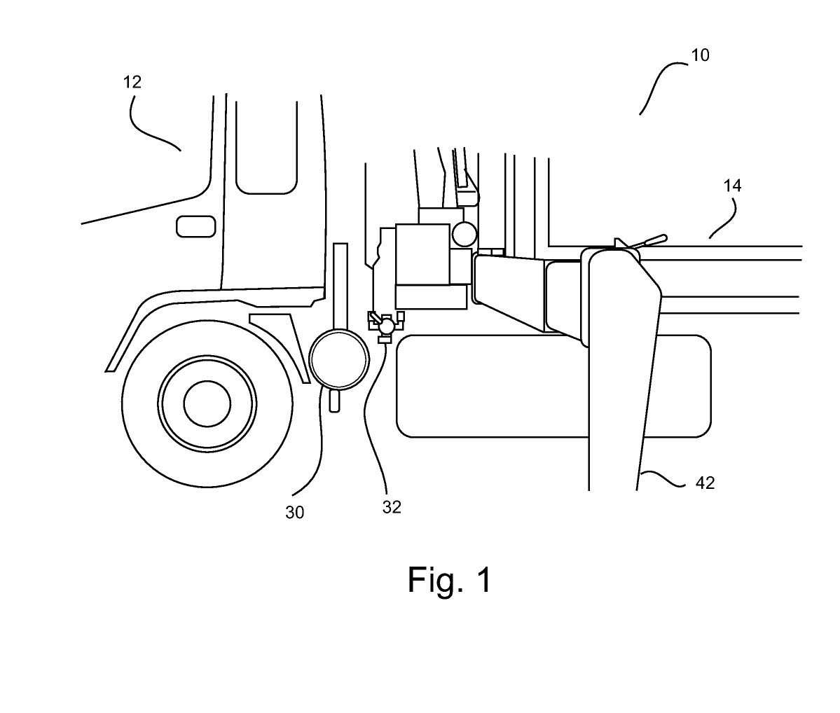

### DETAILED DESCRIPTION OF PREFERRED EMBODIMENTS

Referring to the Figure, there is shown a crane transport vehicle being a truck 10. The truck 10 includes a cab 12 and a crane supporting platform being a truck bed 14.

A first crane 20 is mounted to towards the rear of the truck bed 14. In the embodiment of the drawings, the first crane 20 is a knuckleboom crane which has a maximum lifting moment of 205 kNm, with a maximum outreach of 17 m. The first crane 20 has a slewing angle of 400°

A second crane 22 is mounted towards the front of the truck bed 14. In the embodiment of the drawings, the second crane 22 is a knuckleboom crane which has a maximum lifting moment of 131 kNm, with a maximum outreach of 23 m. The second crane 22 has a slewing angle of 420°.

The first and second cranes 20, 22 are both powered by means of a hydraulic pump 30 which is located underneath the cab 12 of the truck 10. Hydraulic fluid from the pump 30 passes through a valve controlled by a manual switch 32. The manual switch 32 is moveable between a first position in which hydraulic pressure is supplied to the first crane 20, and not to the second crane 22; and a second position in which hydraulic pressure is supplied to the second crane 22 and not to the first crane 20.

The truck 10 includes a first pair of outriggers 40 which extend laterally from the truck 10 at the position of the first crane 20. The truck also includes a second pair of outriggers 42 which extend laterally from the truck 10 at the position of the second crane 22.

The first crane 20 and the second crane 22 are both controllable by an electronic controller (not shown). It is envisaged that a single electronic controller may be used, with appropriate electronic switching means to complement the manual switch 32 such that only one of the cranes 20, 22 can be operated at any one time.

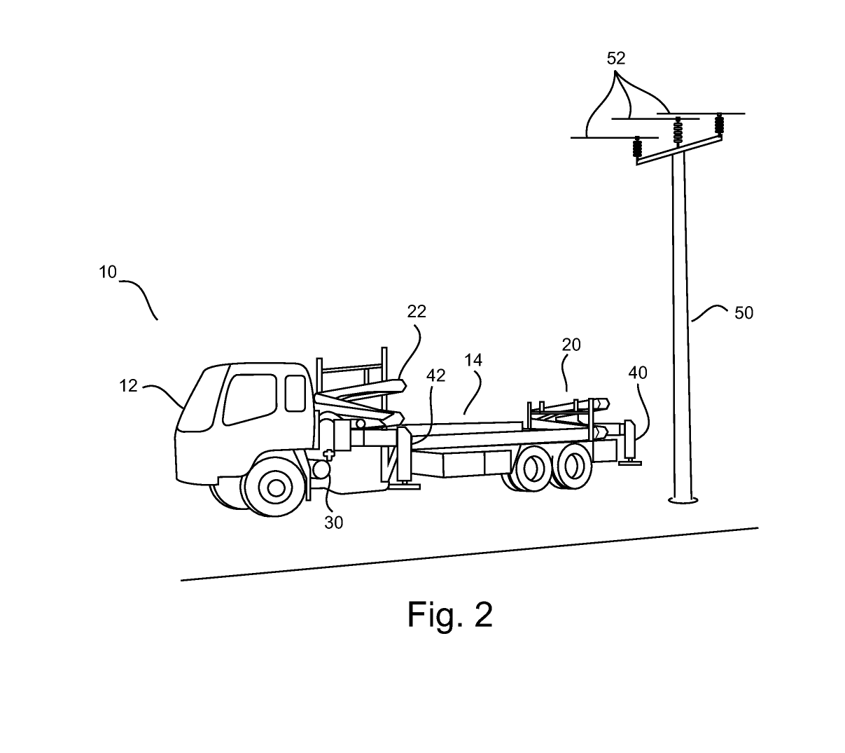

Use of the truck 10 in the replacement of a power pole 50 will now be described with reference to FIGS. 2 to 7. The power pole 50 to be replaced is carrying power lines 52.

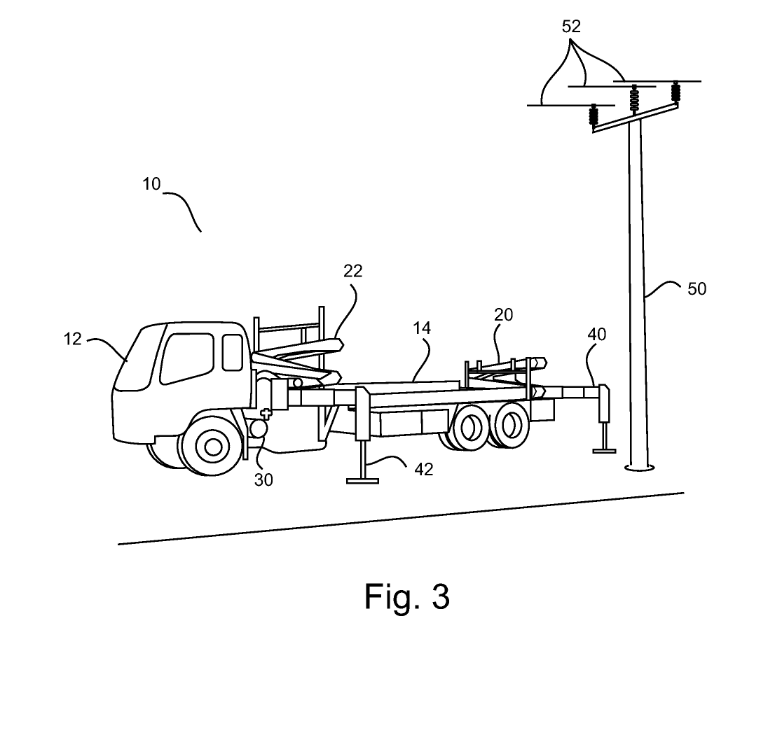

Firstly, an operator drives the truck 10 into a desired position near the power pole 50, as shown in FIG. 2. The first and second outriggers 40, 42 may then be deployed as shown in FIG. 3. It will be appreciated that depending on the relative position of the truck 10 and power pole 50, and the required operations, it may only be necessary to deploy outriggers 40, 42 on the near side of the truck 10.

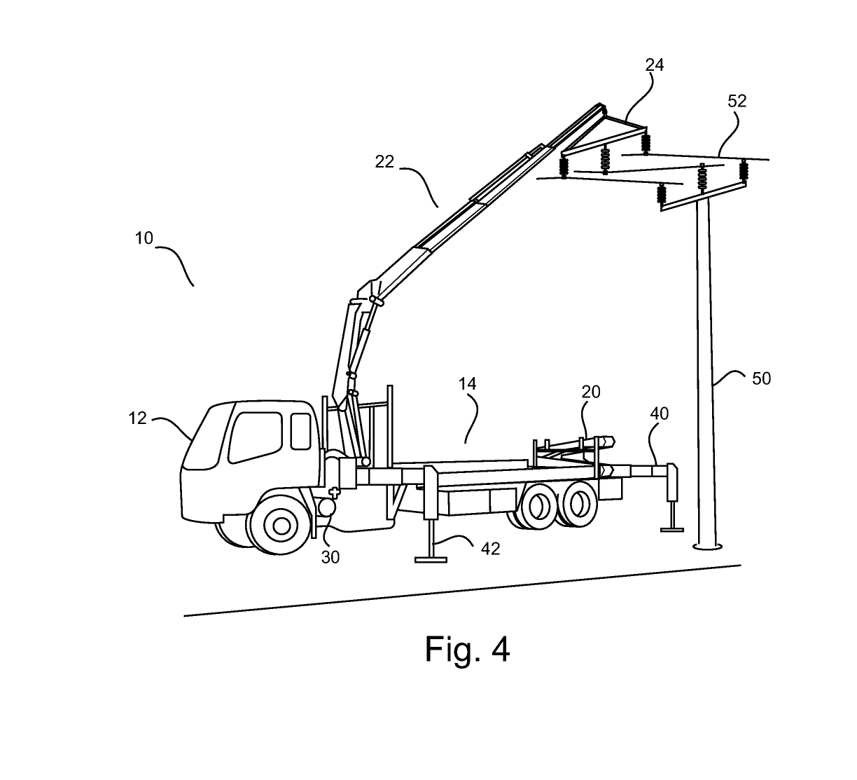

The manual switch 32 is moved into the second position to enable operation of the second crane 22. The second crane 22 can be extended upwardly to the top of the power pole 50. This is shown in FIG. 4.

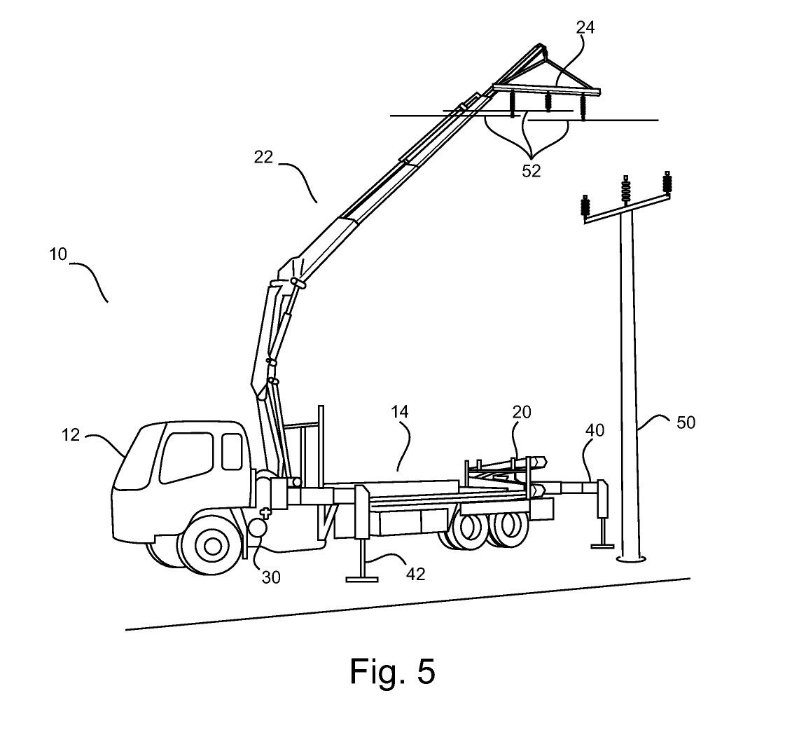

The power lines 52 can then be disconnected from the power pole 50 and attached to a suitable carrier boom 24 on the second crane 22. The second crane 22 can then be operated to lift the power lines 52 safely up and away from the power pole 50. This is shown in FIG. 5.

The manual switch 32 can then be moved into the first position. This has the effect of ceasing the supply of hydraulic pressure to the second crane 22, thus locking it in its extended position; and of supplying hydraulic pressure to the first crane 20, allowing it to be operated.

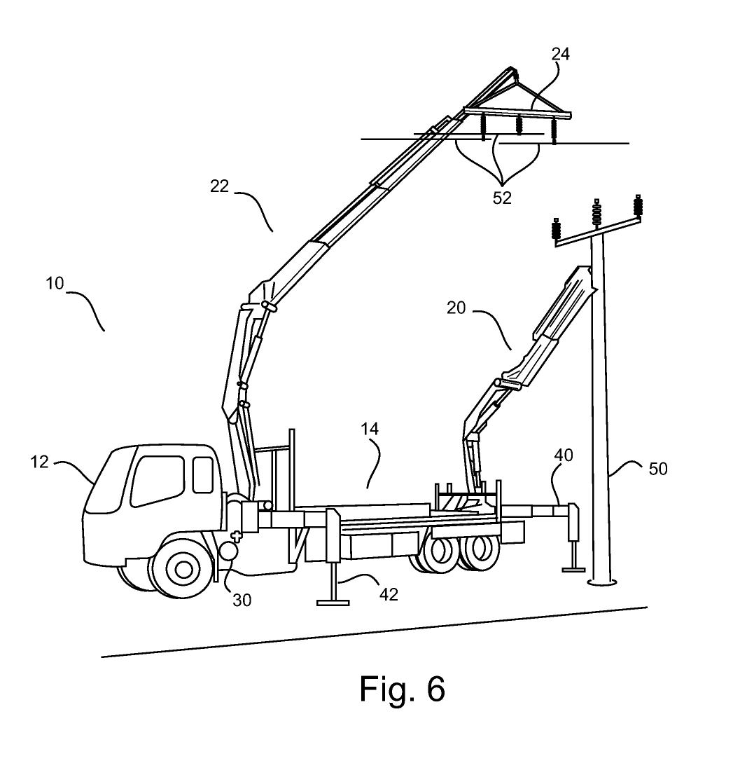

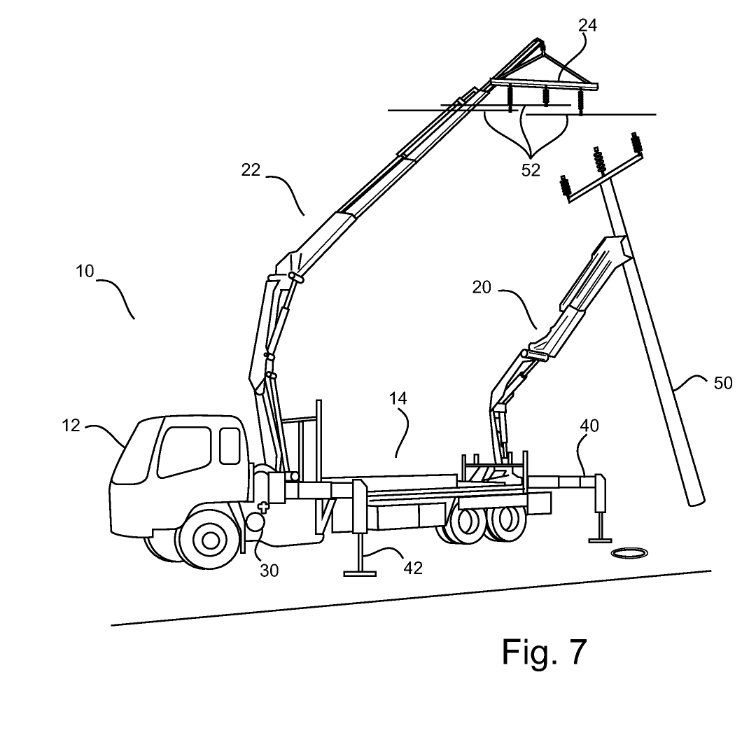

The first crane 20 can then be extended outwardly to grasp the power pole 50, as shown in FIG. 6, and to lift and remove the power pole 50 as shown in FIG. 7.

From this position the first crane 20 can be used to operate a boring device, if required, and to lift and install a new power pole 50. Once the new power pole 50 is in position, the operations described above can be reversed to re-connect the power lines 52 and to retract the cranes 20, 22 and then the outriggers 40, 42.

Further safety mechanisms may be built into the arrangement of the truck 10, in addition to the manual switch 32 (colloquially known as a ‘dead man switch’). These might for instance include position monitoring equipment to ensure that the two cranes cannot touch each other in use.

Modifications and variations as would be apparent to a skilled addressee are deemed to be within the scope of the present invention. For instance, the position and style of the first and second cranes can be chosen to suit a particular purpose. Similarly, although the arrangement has been described in relation to a truck, it will be apparent that it can be similarly deployed on another crane transport vehicle such as a crawler, a tracked vehicle or a railway carriage.

1. A crane transport vehicle, the transport vehicle including a crane supporting platform, wherein at least two separably operable cranes are disposed on the crane supporting platform: each crane being arranged to extend beyond a horizontal periphery of the transport vehicle.

2. A crane transport vehicle as claimed in claim 1, wherein each crane is able to slew through at least 180°.

3. A crane transport vehicle as claimed in claim 2, wherein each crane is able to slew through at least 360°.

4. A crane transport vehicle as claimed in claim 3, wherein each crane is able to slew at through least 400°.

5. A crane transport vehicle as claimed in claim 1, the two separably operable cranes comprising a first crane and a second crane, wherein one of the first and second cranes has a longer reach than the other of the first and second cranes.

6. A crane transport vehicle as claimed in claim 1, the two separably operable cranes comprising a first crane and a second crane, wherein one of the first and second cranes has a greater lifting capacity than the other of the first and second cranes.

7. A crane transport vehicle as claimed in claim 6, wherein one of the first and second cranes has a longer reach than the other of the first and second cranes.

8. A crane transport vehicle as claimed in claim 7, wherein the second crane has a longer reach than the first crane and the first crane has greater lifting capacity than the second crane.

9. A crane transport vehicle as claimed in claim 1, wherein only one crane can be operated at one time.

10. A crane transport vehicle as claimed in claim 9, wherein the cranes are hydraulically operated, and a single hydraulic pump is used to supply hydraulic pressure to both cranes.

11. A crane transport vehicle as claimed in claim 10, wherein a selectively operable switching means is used to cause the supply of hydraulic pressure to only operate a chosen one of the two cranes at any one time.

12. A crane transport vehicle as claimed in claim 1, wherein the crane supporting platform represents a bed of the vehicle, with a first crane located towards the rear of the bed and a second crane located towards the front of the bed.

13. A crane transport vehicle as claimed in claim 12, wherein the vehicle includes extendable outriggers.

14. A crane transport vehicle as claimed in claim 13, wherein the vehicle includes at least two sets of outriggers, one associated with each crane.

15. A crane transport vehicle as claimed in claim 1, wherein the vehicle is a truck.

16. A crane transport vehicle as claimed in claim 15, wherein the vehicle is a truck for the service and replacement of power poles.

17. A method of replacing power poles using a truck, the method including the step of using a first crane mounted on the truck to remove a power pole while using a second crane mounted on the same truck to hold power lines in position.
